(19) United States
(12) Patent Application Publication
(10) Pub. No.: US 2018/0159670 A1
(43) Pub. Date: Jun. 7, 2018

(54) MULTI-CELL SYSTEM AND CHANNEL CALIBRATION METHOD THEREOF

(71) Applicant: INDUSTRIAL TECHNOLOGY RESEARCH INSTITUTE, Hsinchu (TW)

(72) Inventors: Jen-Yuan HSU, Jincheng Township (TW); Jia-Ming CHEN, Taipei City (TW); Jiun-Yo LAI, Zhudong Township (TW); Ming-Che LIN, Longjing Township (TW)

(21) Appl. No.: 15/833,416

(22) Filed: Dec. 6, 2017

Related U.S. Application Data
(63) Continuation-in-part of application No. 15/391,146, filed on Dec. 27, 2016, now abandoned.

(30) Foreign Application Priority Data
Dec. 7, 2016 (TW) 105140409
Oct. 25, 2017 (TW) 106136744

(51) Int. Cl. H04L 5/00; H04W 72/04; H04W 56/00

(52) U.S. Cl. CPC H04L 5/0032; H04W 72/0413; H04W 72/082; H04W 56/0015; H04L 5/0048

(57) ABSTRACT

A multi-cell system includes a coordination server connected to a plurality of base stations having a plurality of base station antennas, and at least one reference device. The reference device is connected wirelessly to the base stations, and a plurality of reference device antennas are disposed on the reference device. The coordination server derives a plurality of relative carrier frequency offsets (CFO) according to a plurality of uplink channel information, derived according to a plurality of uplink reference signals transmitted by the reference device antennas of the reference device, received from the base stations. The coordination server derives a plurality of channel calibration factors according to the uplink channel information, the relative CFOs and a plurality of downlink channel information, derived according to a plurality of downlink reference signals transmitted by at least one base station antenna of each of the base stations, received from the reference device.

This is a continuation-in-part application of application Ser. No. 15/391,146, filed on Dec. 27, 2016. This application claims the benefit of Taiwan application Serial No. 105140409, filed Dec. 7, 2016, and Serial No. 106136744, filed Oct. 25, 2017, the subject matters of which are incorporated herein by references.

### BACKGROUND

### Technical Field

This disclosure relates to a multi-cell system and a channel calibration method thereof.

### Description of the Related Art

Multi-cell system, especially multi-cell coordination system (MCC system), by coordinating a plurality of base stations to perform data transmission with users, may achieve the equivalent of performance of massive antenna.

In multi-cell system, since the clock source of each base station is independent,there may be a carrier frequency offset (CFO) between one base station and another. CFO may lead to, for example, sampling clock offset (SCO), the downlink and uplink channels have opposite linear phases and so on, thereby causing Inter-Cell Interference (ICI) and Inter-User Interference (IUI), and the system capacity is reduced.

### SUMMARY

The disclosure relates to a multi-cell system and a channel calibration method of the multi-cell system, which is used to calibrate the channels of the multi-cell system.

An embodiment of the present disclosure discloses a multi-cell system comprising a coordination server which is communicated with a plurality of base stations including a plurality of base station antennas, and at least one reference device. The at least one reference device is communicated wirelessly with the base stations, and a plurality of reference device antennas are disposed on the at least one reference device. The coordination server derives a plurality of relative carrier frequency offsets (CFO) according to a plurality of uplink channel information received from the base stations, the uplink channel information are derived, by the base stations, according to a plurality of uplink reference signals transmitted from the reference device antennas of the at least one reference device. The coordination server derives a plurality of channel calibration coefficients according to the uplink channel information, the relative CFOs and a plurality of downlink channel information received from the at least one reference device, wherein the downlink channel information are derived, by the at least one reference device, according to a plurality of downlink reference signals transmitted from at least one of the base station antennas among the base station antennas of each of the base stations.

An embodiment of the present disclosure discloses a channel calibration method of a multi-cell system comprising following steps: deriving, by a coordination server, a plurality of relative carrier frequency offsets (CFO) according to a plurality of uplink channel information received from a plurality of base stations, wherein the uplink channel information are derived, by the base stations, according to a plurality of uplink reference signals transmitted from a plurality of reference device antennas disposed on at least one reference device; and deriving, by the coordination server, a plurality of channel calibration coefficients according to the uplink channel information, the relative CFOs and a plurality of downlink channel information received from the at least one reference device, wherein the downlink channel information are derived, by the at least one reference device, according to a plurality of downlink reference signals transmitted from at least one base station antenna among a plurality of base station antennas of each of the base stations.

An embodiment of the present disclosure discloses a channel calibration method of multi-cell system, which may include: transmitting, by a reference device, the uplink reference signal to a plurality of base stations via uplink channels of the plurality of base stations so as to transmit a plurality of uplink channel information based on the uplink reference signal from the plurality of base stations to a coordination server; estimating relative carrier frequency offsets (CFOs) among the plurality of base stations by the plurality of uplink channel information; transmitting, by the plurality of base stations, the downlink reference signal to the reference device so as to transmit a plurality of downlink channel information based on the downlink reference signal from the reference device to the coordination server; and performing, by the coordination server, a time-varying channel calibration for the plurality of base stations according to the relative CFOs and the plurality of downlink channel information.

An embodiment of the present disclosure discloses a system of coordinating multi-cells, which may include: a coordination server; a plurality of base stations configured for exchanging data with the coordination server; and a reference device configured for exchanging data with the coordination server and connected with the plurality of base stations through wireless transmission, wherein the reference device transmits the uplink reference signal to the plurality of base stations via uplink channels of the plurality of base stations so as to transmit a plurality of uplink channel information based on the uplink reference signal from the plurality of base stations to the coordination server, the plurality of base stations transmit the downlink reference signal to the reference device so as to transmit a plurality of downlink channel information based on the downlink reference signal from the reference device to the coordination server, relative carrier frequency offsets (CFOs) among the plurality of base stations are estimated according to the plurality of uplink channel information, and the coordination server performs a time-varying channel calibration for the plurality of base stations according to the relative CFOs and the plurality of downlink channel information.

The multi-cell system and the channel calibration method according to the present disclosure may not only effectively reduce the influence caused by the CFO when the base stations cooperate, but also solve the problem that the channel calibration is inaccurate due to frequency selective fading.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a system block diagram of a multi-cell system according to an embodiment of the disclosure.

FIGS. 2A and 2B show flowcharts of a channel calibration method of a multi-cell system according to an embodiment of the disclosure.

FIG. 3 shows a link model which is used in an embodiment of the disclosure.

FIG. 4 shows a timing diagram of an example of a multi-cell system according to an embodiment of the disclosure.

FIG. 5 shows a timing diagram of another example of a multi-cell system according to an embodiment of the disclosure.

FIG. 6 shows a system block diagram of a multi-cell system according to another embodiment of the disclosure.

FIG. 7 shows a schematic diagram illustrating the present disclosure realizing inter-eNB CFO (relative CFO) estimation.

FIGS. 8A and 8B shows flowcharts illustrating multi-cell coordination and channel calibration according to the present disclosure.

FIGS. 9 to 11 are schematic diagrams illustrating the allocations of a reference signal in frames according to the present disclosure.

FIG. 12 is a graph showing simulation of estimation performance for CFO among eNBs according to the present disclosure.

FIG. 13 is a graph illustrating a cumulative distribution function of inter-cell interference between eNBs.

FIG. 14 is a schematic diagram of the present disclosure applied to a Wi-Fi system.

### DETAILED DESCRIPTION OF THE INVENTION

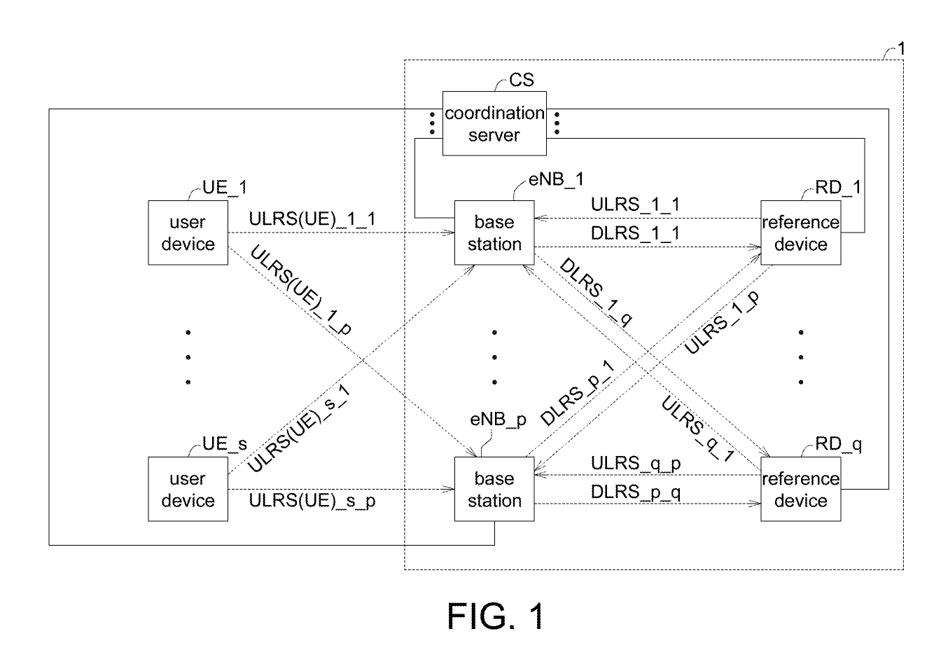

Referring to FIG. 1, FIG. 1 shows a system block diagram of a multi-cell system according to an embodiment of the disclosure. The multi-cell system 1 includes a plurality of base stations eNB_1˜eNB_p, one or more reference device RD_1˜RD_q and a coordination server CS, where p represents the quantity of the base stations and p is an integer greater than 1, q represents the quantity of the reference device(s) and q is an integer greater than or equal to 1. The base stations eNB_1˜eNB_p may have a plurality of base station antennas, for example, the quantity of the base station antennas is Nt, where Nt is an integer greater than 1. The reference device(s) RD_1˜RD_q may have one or more reference device antenna(s), for example, the quantity of the reference device antennas is Nr, where Nr is an integer greater than or equal to 1. The base stations eNB_1˜eNB_p are respectively connected in wireless communication to the reference device(s) RD_1˜RD_q (represented in dotted lines). The base stations eNB_1˜eNB_p and the reference device(s) RD_1˜RD_q are respectively connected in wire communication to the coordination server CS (represented in solid lines). The multi-cell system 1 may be configured to serve user devices UE_1˜UE_s, where s represent the quantity of the user devices and s is an integer greater than or equal to 1. The user devices UE_1˜UE_s may have one or more user device antennas, and may be connected in wireless communication to the base stations eNB_1˜eNB_p. In different embodiments, the quantity of the reference device may be plural and each of the reference devices have one reference device antenna, or the quantity of the reference device is one and the reference device have a plurality of reference device antennas, for transmission. Additionally, in different embodiments, the base station may select some of the base station antennas for transmission according to actual needs, that is, the number of base station antennas used by each base station for transmission may be smaller than the total number of base station antennas that each base station has. However, to simplify the description, the following description takes as an example that the number of base station antennas used for transmission is equal to the total number of base station antennas, but the disclosure is not limited thereto.

The reference devices RD_1˜RD_q and the base stations eNB_1˜eNB_p have respective carrier frequencies. For example, the reference device RD_r (r=1, 2, . . . , q) has a carrier frequency ηᵣ, and the base station eNB_b (b=1, 2, . . . , p) has a carrier frequency ε_{b}. Additionally, the base station eNB_b has a carrier frequency offset (CFO) (ε_{b}−ηᵣ).

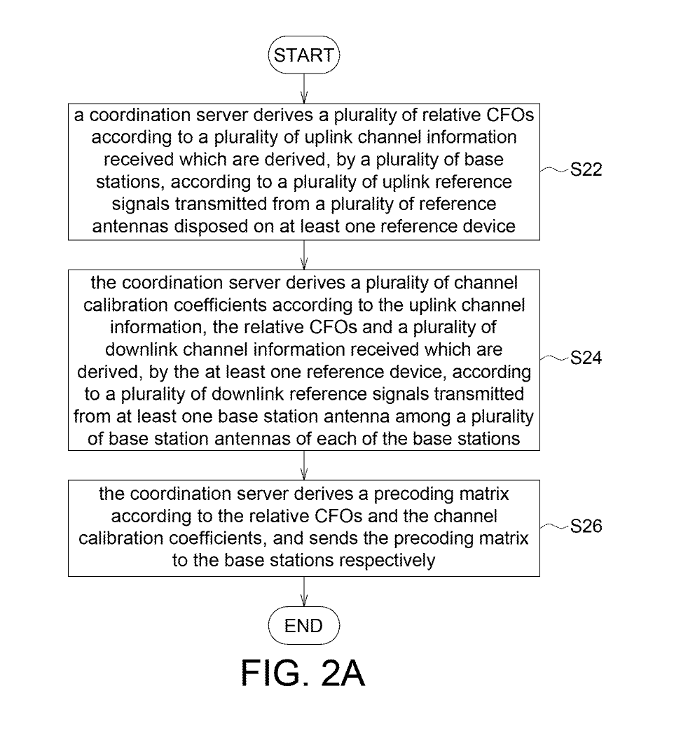

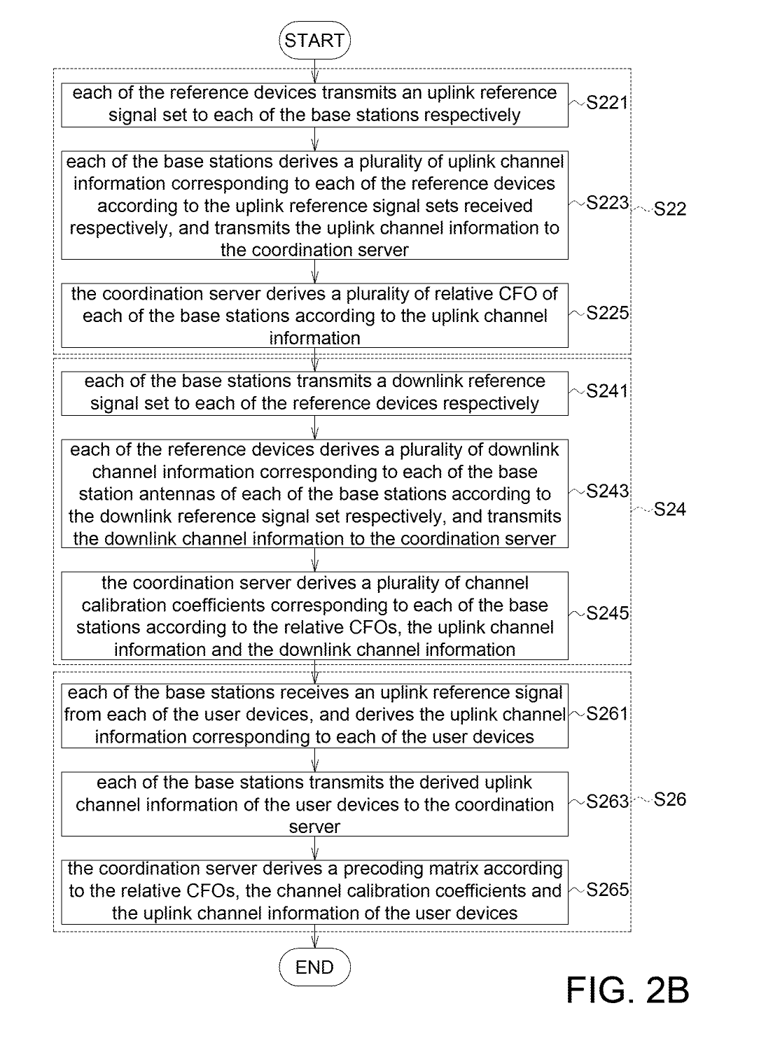

To clearly illustrate the embodiment,the following description may be illustrated with flowcharts of a channel calibration method of a multi-cell system according to an embodiment of the disclosure shown in FIG. 2A and FIG. 2B. The channel correction method shown in FIG. 2A and FIG. 2B that may be used to perform channel calibration on the multi-cell system 1 shown in FIG. 1. More specifically, the channel calibration method shown in FIG. 2A is for performing channel calibration on a downlink channel used when each of the base stations eNB_1˜eNB_p performs downlink transmission to user devices UE_1˜UE_s. As shown in FIG. 2A, the channel calibration method includes step S22, step S24 and step S26.

In step S22, a coordination server derives a plurality of relative CFOs according to a plurality of uplink channel information received which are derived, by a plurality of base stations, according to a plurality of uplink reference signals transmitted from a plurality of reference device antennas disposed on at least one reference device.

In step S24, the coordination server derives a plurality of channel calibration coefficients according to the uplink channel information, the relative CFOs and a plurality of downlink channel information received which are derived, by the at least one reference device, according to a plurality of downlink reference signals transmitted from at least one base station antenna among a plurality of base station antennas of each of the base stations. In an embodiment, each of the base stations may choose at least one of the base station antennas to perform transmission.

In step S26, the coordination server derives a precoding matrix according to the relative CFOs and the channel calibration coefficients, and sends the precoding matrix to the base stations respectively.

Further, for the details of the steps S22, S24 and S26 as shown in FIG. 2B, the step S22 includes steps S221, S223 and S225. The step S24 includes steps S241, S243 and S245. The step S26 includes steps S261, S263 and S265. The details of each step may be described below.

In step S221, each of the reference devices RD_1˜RD_q transmits an uplink reference signal set ULRS_1_1˜ULRS_q_p to each of the base stations eNB_1˜eNB_p respectively. For example, the reference device RD_1 transmits the uplink reference signal set ULRS_1_1˜ULRS_1_p to the base station eNB_1˜eNB_p respectively. That is, the reference device RD_1 transmits the uplink reference signal sets ULRS_1_1 to the base station eNB_1, and transmits the uplink reference signal set ULRS_1_2 to the base station eNB_2, and so forth.

Further, taking the reference device RD_r havening a plurality of reference device antennas as an example, the uplink reference signal set ULRS_r_b transmitted to the base station eNB_b by the reference device RD_r includes the uplink reference signal transmitted via a first reference device antenna by the transceiver of the reference device RD_r to the uplink reference signal transmitted via a Nrth reference device antenna by the transceiver of the reference device RD_r (that is, the quantity of uplink reference signals transmitted by the reference device RD_r is Nr in total).

Further, when transmitting the uplink reference signal set ULRS_r_b to the base station eNB_b by the reference device RD_r, it may be affected by different initial phases due to the differences of the transmitting reference device antenna and the receiving base station antenna. For example, the uplink reference signal transmitted via the first reference device antenna of the reference device RD_r may be affected by the initial phase θ_{r,1} of the transmitter, the uplink reference signal transmitted via the second reference device antenna of the reference device RD_r may be affected by the initial phase θ_{r,2} of the transmitter, and so forth. Similarly, the uplink reference signal received via the first base station antenna of the base station eNB_b may be affected by the initial phase ϕ_{b,1} of the transmitter, the uplink reference signal received via the second base station antenna of the base station eNB_b may be affected by the initial phase ϕ_{b,2} of the transmitter, and so forth.

In step S223, each of the base stations eNB_1˜eNB_p derives a plurality of uplink channel information corresponding to each of the reference devices RD_1˜RD_q according to the uplink reference signal sets ULRS_1_1˜ULRS_q_p received respectively, and transmits the uplink channel information to the coordination server CS. For example, the base station eNB_1 may receive the uplink reference signals from the first reference device antenna to the Nrth reference device antenna of the reference device RD _1 (i.e., the uplink reference signal set ULRS_1_1), the uplink reference signals from the first reference device antenna to the Nrth reference device antenna of the reference device RD_2 (i.e., the uplink reference signal set ULRS_2_1), and so on. Then, the base station eNB_1 derives the uplink channel information corresponding to each of the reference device antennas of the reference device RD_1 according to the uplink reference signal set ULRS_1_1, and derives the uplink channel information corresponding to each of the reference device antennas of the reference device RD_2 according to the uplink reference signal set ULRS_2_1, and so on.

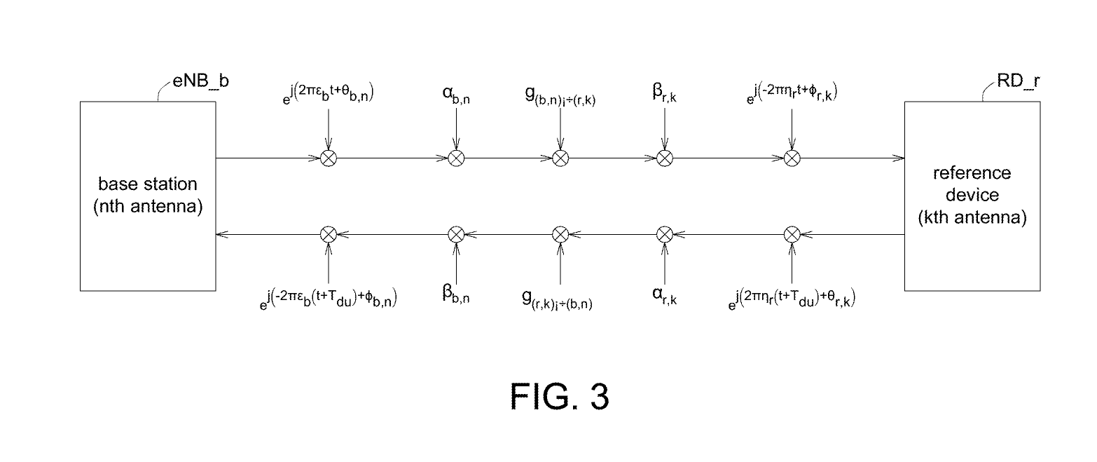

Before illustrating details of step S223, please refer to FIG. 3, FIG. 3 shows a link model which is used in an embodiment of the disclosure. In FIG. 3, the leftmost square represents the nth base station antenna (n=1, 2, . . . Nt) of the base station eNB_b and the rightmost square represents the kth reference device antenna (k=1, 2, . . . , Nr) of the reference device RD_r. The upper arrow (directed from the nth antenna (base station antenna) of the base station eNB_b to the kth antenna (reference device antenna) of the reference device RD_r) represents the downlink. The lower arrow (directed from the kth antenna (reference device antenna) of the reference device RD_r to the nth antenna (base station antenna) of the base station eNB_b) represents the uplink. α represents radio frequency (IRF) response of the transmitter, for example, α_{b,n} represents the RF response of the nth antenna of the base station eNB_b when the nth antenna of the base station eNB_b is the transmitter, and α_{r,k} represents the RF response of the kth antenna of the reference device RD_r when the kth antenna of the reference device RD_r is the transmitter. β represents radio frequency (RF) response of the receiver, for example, β_{b,n} represents the RF response of the nth antenna of the base station eNB_b when the nth antenna of the base station eNB_b is the receiver, and β_{r,k} represents the RF response of the kth antenna of the reference device RD_r when the kth antenna of the reference device RD_r is the receiver. g_{(b,n)→(r,k)} and g_{(r,k)→(b,n)} represent the channels in the air, when the channels in the air are reciprocity, g_{(b,n)→(r,k)} and g_{(r,k)→(b,n)} may be equivalent.

After understanding the link model used in this embodiment,the detailed description of step S223 is continued. Based on the link model shown in FIG. 3, the uplink channel information Ĥ_{r→b}(t) corresponding to the reference device RD_r derived by the base station eNB_b according to the uplink reference signal set ULRS_r_b may be expressed as a complex matrix with dimensions of Nt×Nr (that is, with Nt columns and Nr rows), where the element of the kth row and the nth column (i.e., element (n,k)) of Ĥ_{r→b}(t) may be expressed as below:
h_{(r,k)→(b,n)}(t)=β_{b,n}·g_{(r,k)→(b,n)}·α_{r,k}e^{j(-2π(ε}^{_{b}}^{-η}^{ᵣ}^{)t+θ}^{_{r,k}}^{-ϕ}^{_{b,n}}⁾+z_{b}(t), where z_{b}(t) is a term of noise.

From the above formula, Ĥ_{r→b}(t) is the uplink channel information observed by the base station eNB_b, which may be regarded as the uplink channel observed by the base station eNB_b, is different from the actual uplink channel due to the influence of the initial phase and the CFO. Therefore, Ĥ_{r→b}(t) may be concerned as the actual uplink channel H_{r→b}(t) multiplied by a term comprising the initial phases and the CFOs, and plus the term of noise.

In step S225, the coordination server CS derives a plurality of relative CFO of each of the base stations eNB_1˜eNB_p according to the uplink channel information. The relative CFO refers to the difference of CFO between a reference base station, which is selected among the base stations eNB_1˜eNB_p, and the other base stations. For example, assuming that the base station eNB_1 is selected as the reference base station, the difference of CFO between the base station eNb_2 and the base station eNb_1 is the relative CFO of the base station eNb_2, and so forth. Details of the coordination server CS calculating the relative CFO may be further illustrated below.

Firstly, assuming that the base station eNB_1 is selected as the reference base station. A parameter matrix G_{1b}(t) is defined as below:

G_{1b}(t)=Ĥ_{r→1}^{H}(t)Ĥ_{r→b}(t)=H_{r→1}^{H}(t)H_{r→b}(t)·e^{j(2π(ε}^{₁}^{-ε}^{_{b}}^{)t+ϕ}^{₁}^{-ϕ}^{_{b}}⁾+z_{1b}^{c}(t),

where Ĥ_{r→1}(t) is a matrix of the uplink channels from all the reference device antennas of the reference device RD_r to all the base station antennas of the base station eNB_1, which includes the uplink channel information, derived by the base station eNB_1; Ĥ_{r→1}^{H}(t) is a Hermitian matrix of Ĥ_{r→1}(t); H_{r→b} is a matrix of the actual uplink channels from the reference device RD_r to the base station eNB_b; Ĥ_{r→1}^{H}(t) is a Hermitian matrix of a matrix of the actual uplink channels from the reference device RD_r to the base station eNB_1; z_{1b}^{c}(t) is a term of noise.

Then, after a time period D, a parameter matrix G_{1b}(t+D) may be derived as below:

G_{1b}(t+D)=H_{r→1}^{H}(t+D)H_{r→b}(t+D)·e^{j(2π(ε}^{₁}^{-ε}^{_{b}}^{)t+2π(ε}^{₁}^{-ε}^{_{b}}^{)D+ϕ}^{₁}^{-ϕ}^{_{b}}⁾+z_{1b}^{c}(t+D).

Another parameter R_{1b}(t,t+D) may be derived by perform complex conjugate multiplication with G_{1b}(t) and G_{1b}(t+D) as below:
R_{1b}(t,t+D)=G*_{1b}(t)G_{1b}(t+D)=H_{r→1}^{H}(t)H_{r→b}(t)H_{r→1}^{H}(t+D)H_{r→b}(t+D)·e^{j2π(ε}^{₁}^{-ε}^{_{b}}^{)D}+v(t,t+D), where v(t,t+D) is a term deriving from noise.

Without loss of generality, the uplink channels does not change much in the time period D (i.e., the change of the uplink channels may be ignored). Thus, H_{r→1}^{H} may be regarded as equal to H_{r→1}^{H}(t), and H_{r→b}(t+D) may be regarded as equal to H_{r→b}(t). R_{1b}(t,t+D) may be rewritten as below:

R_{1b}(t,t+D)=|H_{r→1}^{H}(t)H_{r→b}(t)|²·e^{j2π(ε}^{₁}^{-ε}^{_{b}}^{)D}+v(t,t+D).

Then, after the coordination server CS completes calculations according to all the uplink channel information (corresponding to the reference devices RD_1˜RD_q) from the base station eNB_{—b} by using the way shown above, the coordination server CS combines all calculation results by weight combining, for example, maximum ratio combining. The combined result is shown as below:

R_{1b}(t,t+D)=Σᵣ₌₁^{q}|H_{r→1}^{H}(t)H_{r→b}(t)|²·e^{j2π(ε}^{₁}^{-ε}^{_{b}}^{)D}+v(t,t+D).

From the above formula, the relative CFO of the base station eNB_b relative to the base station eNB_1(ε₁−ε_{b}) may be derived from the phase of R_{1b}(t,t+D). In addition, R_{1b}(t,t+D) derived by using maximum ratio combining includes a first gain, i.e., Σᵣ₌₁^{q}|H_{r→1}^{H}(t)H_{r→b}(t)|², on the term e^{j2π(ε}^{₁}^{-ε}^{_{b}}^{)D} which relates to the relative CFO. When the quantity of the reference device RD_1˜RD_q is larger (that is, the value of q is larger), the first gain is larger, so that the ratio of the term with the first gain to v(t,t+D) is larger. In other words, by weight combining (e.g., maximum ratio combining), the influence of noise may be reduced, and the accuracy of calculating the relative CFO may be increased. It should be noted that the combination manner illustrated above is merely an example, and the present disclosure is not limited by.

In addition to employ maximum ratio combining as the weight combining illustrated above, such as equal gain combining, switching combining, and selection combining may also be employed.

After performing the calculations shown above, the relative CFO \hat{ε}_{1b} of the base station eNB_b derived by the coordination server CS may be expressed as below:

$${\hat{ɛ}}_{1 b} = {ɛ}_{1} - {ɛ}_{b} = \frac{1}{2 π D} angle ( {R}_{1 b} ( t , t + D ) ) ,$$

where

$${\hat{ɛ}}_{1 b} = {ɛ}_{1} - {ɛ}_{b} = \frac{1}{2 π D} angle ( {R}_{1 b} ( t , t + D ) )$$

represents to derive the phase of R_{1b}(t,t+D).

It should be noted that \hat{ε}_{1b} is a value derived by the base station eNB_b, that is, an estimated value, which may be different from the actual value. The higher the accuracy of the estimation, \hat{ε}_{1b} may be closer to the actual value.

It is understandable that the above description is taking the base station eNB_b as the example. In practicing operation, the coordination server CS derives, according to the uplink channel information transmitted by each of the base stations eNB_1˜eNB_p respectively, by performing the steps shown above, to obtain the relative CFOs corresponding to each of the base stations eNB_1˜eNB_p.

In step S241, each of the base stations eNB_1˜eNB_p transmits a downlink reference signal set DLRS_1_1˜DLRS_p_q to each of the reference devices RD_1˜RD_q respectively. For example, the base station eNB_1 transmits the downlink reference signal set DLRS_1_1˜DLRS_1_{—q} to the reference device RD_1˜RD_q. That is, the base station eNB_1 transmits the downlink reference signal set DLRS_1_1 to the reference device RD_1, and transmits the downlink reference signal set DLRS_1_2 to the reference device RD_2, and so forth.

Further, the downlink reference signal set DLRS_b_r transmitted to the reference device RD_r by the base station eNB_b includes the downlink reference signal transmitted via a first base station antenna by the transceiver of the base station eNB_b to the downlink reference signal transmitted via a Nrth base station antenna by the transceiver of the base station eNB_b (that is, the quantity of downlink reference signals transmitted by the base station eNB_b is Nt in total).

Similar to the uplink reference signals, the downlink reference signals may be affected by the CFOs due to the difference of the transmitting base stations and the receiving base stations. The downlink reference signal may also be affected by the initial phase of the base station antenna of the transmitting base station and the reference device antenna of the receiving reference device antenna.

In step S243, each of the reference devices RD_1˜RD_q derives a plurality of downlink channel information corresponding to each of the base station antennas of each of the base stations eNB_1˜eNB_p according to the downlink reference signal set DLRS_1_1˜DLRS_p_q respectively, and transmits the downlink channel information to the coordination server CS. For example, the reference device RD_1 may receive the downlink reference signal set DLRS_1_1 from the base station eNB_1, the downlink reference signal set DLRS_2_1 from the base station eNB_2, and so on. Then, the reference device RD_1 may derive the downlink channel information corresponding to each of the base station antennas of the base station eNB_1 according to the downlink reference signal set DLRS_1_1, the downlink channel information corresponding to each of the base station antennas of the base station eNB_2 according to the downlink reference signal set DLRS_2_1, and so forth.

Based on the link model shown in FIG. 3, the downlink channel information h_{(b,n)→(r,k)}(t) of the channel from the nth antenna (base station antenna) of the base station eNB_b to the kth antenna (reference device antenna) of the reference device RD_r may be express as below:
h_{(b,n)→(r,k)}(t)=β_{r,k}·g_{(b,k)→(r,k)·α}_{b,n}·e^{j(2π(\hat{ε}}^{_{1b}}^{-ε}^{_{b}}^{-η}ᵣ^{)t+θ}^{_{b,n}}^{+ϕr,k)}, where θ_{b,n} is the initial phase of the nth antenna of the base station eNB_b, and ϕ_{r,k} is the initial phase of the kth antenna of the reference device RD_r. To be noted, without loss of generality, the noise item is omitted to simplify calculation and explanation.

In step S245, the coordination server CS derives a plurality of channel calibration coefficients corresponding to each of the base stations eNB_1˜eNB_p according to the relative CFOs, the uplink channel information and the downlink channel information. The details of the channel calibration coefficients may be further illustrated below.

At the time (t+T_{du}), the uplink channel information of the channel from the reference device RD_r to the base station eNB_b may be expressed as below:

h_{(r,k)→(b,n)}(t+T_{du})=β_{b,n}·g_{(r,k)→(b,n)}·α_{r,k}·e^{j(-2π(η}^{ᵣ}^{-ε}^{_{b}}^{+\hat{ε}}_{1b}^{)(t+T}^{_{du}}^{)+θ}^{_{r,k}}^{+ϕ}^{_{b,n}}⁾,

where T_{du} is the time interval between transmitting the downlink reference signal and transmitting the uplink reference signal; θ_{r,k} is the initial phase of the kth antenna of the reference device RD_r; ϕ_{b,n} is the initial phase of the nth antenna of the base station eNB_b; \hat{ε}_{b} is the CFO (relative CFO) derived by performing the steps describe above; and (ε_{b}−\hat{ε}_{b}) represents the difference between the derived CFO (relative CFO) and the actual CFO (relative CFO), i.e., estimation error.

More specifically, in this embodiment, in the first time period D (t=0˜D), the coordination server CS derives a plurality of first relative CFOs as initial values. In the second time period D (t=D˜2D), the coordination server CS derives a plurality of second relative CFOs, and derives the channel calibration coefficients according to the first relative CFOs derived in the first time period D. In other words, the coordination server CS derives the channel calibration coefficients based on the previous derived relative CFO.

The channel calibration coefficient c_{(b,n)→(r,k)}(t+T_{du}) may be expressed as below:

$${c}_{( b , n ) \to ( r , k )} ( t + {T}_{du} ) = \frac{{h}_{( b , n ) \to ( r , k )} ( t )}{{h}_{( r , k ) \to ( b , n )} ( t + {T}_{du} )} = \frac{\frac{{α}_{b , n}}{{β}_{b , n}}}{\frac{{α}_{r , k}}{{β}_{r , k}}} {e}^{j ( 4 π {\hat{ɛ}}_{1 b} t + 2 π ( {η}_{r} - {ɛ}_{b} + {\hat{ɛ}}_{1 b} ) {T}_{du} + {θ}_{b , n} + {φ}_{r , k} - {θ}_{r , k} - {φ}_{b , n} )} = 1 / {c}_{( r , k ) \to ( b , n )} ( t + {T}_{du} ) .$$

Then, for example, channel calibration is performed based on the first antenna of the base station eNB_1, and the calibrated channel calibration coefficient may be expressed as follow:

$$\\ {c}_{( b , n ) \to ( r , k )}^{′} ( t + {T}_{du} ) = \frac{{c}_{( b , n ) \to ( r , k )} ( t + {T}_{du} )}{{c}_{( 1 , 1 ) \to ( r , 1 )} ( t + {T}_{du} )} \approx \frac{\frac{{α}_{b , n}}{{β}_{b , n}} / \frac{{α}_{r , k}}{{β}_{r , k}} {e}^{j ( {θ}_{b , n} + {φ}_{r , k} - {θ}_{r , k} - {φ}_{b , n} )}}{\frac{{α}_{1 , 1}}{{β}_{1 , 1}} / \frac{{α}_{r , 1}}{{β}_{r , 1}} {e}^{j ( {θ}_{1 , 1} + {φ}_{r , 1} - {θ}_{r , 1} - {φ}_{1 , 1} )}} = {e}^{j ϕ r} \frac{\frac{{α}_{b , n}}{{β}_{b , n}}}{\frac{{α}_{1 , 1}}{{β}_{1 , 1}}} \frac{\frac{{α}_{r , 1}}{{β}_{r , 1}}}{\frac{{α}_{r , k}}{{β}_{r , k}}} ,$$

where φᵣ is derived by integrating all the phase terms.

By rewriting the formula above, the relationship between the uplink channel h_{(r,k)→(b,n)} and the downlink channel h_{(b,n)→(r,k)}(t) may be illustrated as below:

$${c}_{( b , n ) \to ( r , k )}^{′} ( t + {T}_{du} ) = \frac{\frac{{h}_{( b , n ) \to ( r , k )} ( t )}{{h}_{( r , k ) \to ( b , n )} ( t + {T}_{du} )}}{\frac{{h}_{( 1 , 1 ) \to ( r , 1 )} ( t )}{{h}_{( r , 1 ) \to ( 1 , 1 )} ( t + {T}_{du} )}} = \frac{\frac{{h}_{( b , n ) \to ( r , k )} ( t )}{{h}_{( 1 , 1 ) \to ( r , 1 )} ( t )}}{\frac{{h}_{( r , k ) \to ( b , n )} ( t + {T}_{du} )}{{h}_{( r , 1 ) \to ( 1 , 1 )} ( t + {T}_{du} )}} = \frac{{h}_{( b , n ) \to ( r , k )}^{′} ( t )}{{h}_{( r , k ) \to ( b , n )}^{′} ( t + {T}_{du} )} \to {h}_{( b , n ) \to ( r , k )}^{′} ( t ) = {h}_{( r , k ) \to ( b , n )}^{′} ( t + {T}_{du} ) {c}_{( b , n ) \to ( r , k )} ( t + {T}_{du} ) {c}_{( 1 , 1 ) \to ( r , 1 )}^{- 1} ( t + {T}_{du} ) \to {c}_{( 1 , 1 ) \to ( r , 1 )} ( t + {T}_{du} ) {h}_{( b , n ) \to ( r , k )}^{′} ( t ) = {h}_{( r , k ) \to ( b , n )}^{′} ( t + {T}_{du} ) {c}_{( b , n ) \to ( r , k )} ( t + {T}_{du} ) .$$

The above formula may be expressed in a matrix form:
C_{(1,1)→(R,K)}·H_{(b,n)→(R,K)}=H_{(R,K)→(b,n)}·C_{(b,n)→(R,K)}(t+T_{du}), where (R,K) represents to “for all (r,k),” that is, from (1,1), (1,2), . . . , (2,1), (2,2), . . . , (q,Nr−1), (q,Nr); C_{(1,1)→(R,K)} represents a channel calibration coefficients matrix of the channels from the first antenna of the base station eNB_1 to the first antenna of the reference device RD_r˜the Nrth antenna of the reference device RD_r (i.e., to each of the reference device antennas of the reference device RD_r); H_{(b,n)→(R,K)} is a downlink channel matrix of the channels from the first antenna of the base station eNB_1 to the first antenna˜the Nrth antenna of the reference device RD_r; C_{(b,n)→(R,K)}(t+T_{du}) represents a channel calibration coefficients matrix of the channels from the first antenna of the reference device RD_r˜the Nrth antenna of the reference device RD_r to the nth antenna of the base station eNB_b; and H_{(R,K)→(b,n)} is a downlink channel matrix of the channels from the first antenna˜the Nrth antenna of the reference device RD_r to the nth antenna of the base station eNB_b.

Combining the channel calibration coefficients corresponding to all the reference devices RD_1˜RD_q by weight combining, e.g., maximum ratio combining, the result may be expressed as below:

$${\hat{c}}_{( b , n ) \to ( R , K )} ( t + {T}_{du} ) = {( {H}_{( R , K ) \to ( b , n )}^{*} {H}_{( R , K ) \to ( b , n )} )}^{- 1} {H}_{( R , K ) \to ( b , n )}^{*} {C}_{( 1 , 1 ) \to ( R , 1 )} {H}_{( b , n ) \to ( R , K )} = \frac{{\sum }_{r = 1}^{Nr} {\sum }_{k = 1}^{Nt} {h}_{( r , k ) \to ( b , n )}^{′ *} ( t + {T}_{du} ) {h}_{( b , n ) \to ( r , k )}^{′} ( t ) {c}_{( 1 , 1 ) \to ( r , 1 )}}{{\sum }_{r = 1}^{R} {\sum }_{k = 1}^{K} {\vert {h}_{( r , k ) \to ( b , n )}^{′} ( t + {T}_{du} ) \vert}^{2}} \approx \frac{{\sum }_{r = 1}^{Nr} {\sum }_{k = 2}^{Nt} \frac{\frac{{α}_{b , n}}{{β}_{b , n}}}{\frac{{α}_{r , k}}{{β}_{r , k}}} \cdot \frac{{\vert {g}_{( b , n ) \to ( r , k )} \vert}^{2}}{{\vert {g}_{( 1 , 1 ) \to ( r , 1 )} \vert}^{2}} \cdot \frac{\frac{{α}_{r , 1}}{{β}_{r , 1}}}{\frac{{α}_{1 , 1}}{{β}_{1 , 1}}} \cdot {e}^{j {ϕ}_{r}}}{{\sum }_{r = 1}^{Nr} {\sum }_{k = 1}^{Nt} \frac{{\vert {h}_{( r , k ) \to ( b , n )} ( t + {T}_{du} ) \vert}^{2}}{{\vert {h}_{( r , 1 ) \to ( 1 , 1 )} ( t + {T}_{du} ) \vert}^{2}}} = \frac{\frac{{α}_{b , n}}{{β}_{b , n}}}{\frac{{α}_{1 , 1}}{{β}_{1 , 1}}} \cdot \frac{{\sum }_{r = 1}^{Nr} {\sum }_{k = 2}^{Nt} {e}^{j {ϕ}_{r}} \cdot \frac{\frac{{α}_{r , 1}}{{β}_{r , 1}}}{\frac{{α}_{r , k}}{{β}_{r , k}}} \cdot \frac{{\vert {g}_{( b , n ) \to ( r , k )} \vert}^{2}}{{\vert {g}_{( 1 , 1 ) \to ( r , 1 )} \vert}^{2}}}{{\sum }_{r = 1}^{Nr} {\sum }_{k = 1}^{Nt} \frac{{\vert {h}_{( r , k ) \to ( b , n )} ( t + {T}_{du} ) \vert}^{2}}{{\vert {h}_{( r , 1 ) \to ( 1 , 1 )} ( t + {T}_{du} ) \vert}^{2}}}$$

From the above formula, a second gain

$$\frac{{\sum }_{r = 1}^{Nr} {\sum }_{k = 2}^{Nt} {e}^{j {ϕ}_{r}} \cdot \frac{\frac{{α}_{r , 1}}{{β}_{r , 1}}}{\frac{{α}_{r , k}}{{β}_{r , k}}} \cdot \frac{{\vert {g}_{( b , n ) \to ( r , k )} \vert}^{2}}{{\vert {g}_{( 1 , 1 ) \to ( r , 1 )} \vert}^{2}}}{{\sum }_{r = 1}^{Nr} {\sum }_{k = 1}^{Nt} \frac{{\vert {h}_{( r , k ) \to ( b , n )} ( t + {T}_{du} ) \vert}^{2}}{{\vert {h}_{( r , 1 ) \to ( 1 , 1 )} ( t + {T}_{du} ) \vert}^{2}}}$$

may be increased on the channel calibration coefficient by using maximum ratio combining. From the second gain, when the quantity of the antennas of the reference device RD_1˜RD_q is larger (i.e., Nr is larger), the second gain may become larger. In other words, when there exists frequency selective fading between the base stations eNB_1˜eNB_p and the reference devices RD_1˜RD_q (that is, some of the channels may fade more seriously resulting in poor transmission quality), the second gain from multiple antennas may compensate for the effects caused by the channels with poor transmission quality and makes channel calibration more accurate.

In addition to employ maximum ratio combining as the weight combining illustrated above, such as equal gain combining, switching combining, and selection combining may also be employed.

In this embodiment,the derivation of the precoding matrix may exemplarily employ zero forcing to perform calculation.

In step S261, each of the base stations eNB_1˜eNB_p receives an uplink reference signal ULRS(UE)_1_1˜ULRS(UE)_s_p from each of the user devices UE_1˜UE_s, and derives the uplink channel information corresponding to each of the users device UE_1˜UE_s. Details of derivation are similar to description illustrated above.

In step S263, each of the base stations eNB_1˜eNB_p transmits the derived uplink channel information of the user devices UE_1˜UE_s to the coordination server CS.

In step S265, the coordination server CS derives the precoding matrix according to the relative CFOs, the channel calibration coefficients and the uplink channel information of the user devices UE_1˜UE_s. Details are illustrated below.

For user device UE_u (u=1, 2, . . . , s), the coordination server CS derives a downlink channel information of the user device UE_u according to the uplink channel information of the user device UE_u:

$${\hat{h}}_{( b , n ) \to ( u , 1 )} ( t + {T}_{du} ) = {\hat{c}}_{( b , n ) \to ( R , K )} ( t + {T}_{du} ) {h}_{( u , 1 ) \to ( b , n )} ( t + {T}_{du} ) = {\hat{c}}_{( b , n ) \to ( R , K )} ( t + {T}_{du} ) \cdot {c}_{( b , n ) \to ( u , 1 )}^{- 1} ( t + {T}_{du} ) \cdot {h}_{( b , u ) \to ( u , 1 )} ( t + {T}_{du} ) = \frac{{h}_{( u , 1 ) \to ( b , n )} ( t + {T}_{du} )}{{\hat{c}}_{( R , K ) \to ( u , 1 )} ( t + {T}_{du} )} {e}^{j ( \frac{- 2 π ( {ɛ}_{b} - {δ}_{u} ) {T}_{du}}{T} )} ,$$

where δᵤ is the CFO of the user device UE_u; and ĉ_{(b,n)→(R,K)}(t+T_{du}) is the channel calibration coefficients derived from the reference devices RD_1˜RD_q and the base stations eNB_1˜eNB_p. In other words, the coordination server CS derives the downlink channel information according to the channel calibration coefficients derived from the reference devices RD_1˜RD_q and the base stations eNB_1˜eNB_p.

The downlink channel information of all the user devices UE_1 UE_s may be expressed in matrix as below:

$$\hat{H} ( t + {T}_{du} ) = [ \begin{matrix}{c}_{( R , K ) \to ( u , 1 )}^{- 1} ( t + {T}_{du} ) & 0 & 0 \\ 0 & ⋱ & 0 \\ 0 & 0 & {c}_{( R , K ) \to ( s , 1 )}^{- 1} ( t + {T}_{du} )\end{matrix} ] \cdot [ \begin{matrix}{e}^{j ( - \frac{2 π ( {ɛ}_{1} - {δ}_{1} ) {T}_{ud}}{T} ) {h}_{( 1 , 1 ) \to ( b , 1 )} ( t + {T}_{du} )} & … & {e}^{j ( - \frac{2 π ( {ɛ}_{p} - {δ}_{1} ) {T}_{du}}{T} ) {h}_{( 1 , 1 ) \to ( p , 1 )} ( t + {T}_{du} )} \\ ⋮ & ⋱ & ⋮ \\ {e}^{j ( - \frac{2 π ( {ɛ}_{1} - {δ}_{s} ) {T}_{ud}}{T} ) {h}_{( s , 1 ) \to ( b , 1 )} ( t + {T}_{du} )} & … & {e}^{j ( - \frac{2 π ( {ɛ}_{p} - {δ}_{s} ) {T}_{du}}{T} ) {h}_{( s , 1 ) \to ( p , 1 )} ( t + {T}_{du} )}\end{matrix} ] = {C}_{( R , K )}^{- 1} ( t + {T}_{du} ) {H}^{CFO} ( t + {T}_{du} ) ,$$

where H^{CFO}(t+T_{du}) is a matrix of CFO terms.

Then, the precoding matrix F_{ZF}(t+T_{du}) may exemplarily be derived by zero forcing as below:

F_{ZF}(t+T_{du})=Ĥ^{H}(t+T_{du}))(Ĥ(t+T_{du})Ĥ^{H}(t+T_{du}))⁻¹.

Then, the coordination server CS transmits the precoding matrix to the base stations eNB_1˜eNB_p. Since the precoding matrix includes information of relative CFOs and channel calibration coefficients, the base stations eNB_1˜eNB_p may perform channel calibration by using precoding matrix during performing downlink transmission with user device UE_1˜UE_s, so that the cooperation between the base stations eNB_1˜eNB_p is further synchronized, and further better service quality may be obtained for the user devices UE_1˜UE_s.

In other embodiment,the quantity of the reference device is one, and the reference device has two or more antennas to obtain diversity gain and to compensate the information provided by the antenna fading seriously; or, the quantity of the reference devices is two or more, and each of the reference devices has one antenna so that the effects caused by the channel which is seriously fading may be compensated when frequency selective fading occurs.

In the various embodiments, the base stations eNB_1˜eNB_p may be an evolved node (eNB). The reference devices RD_1˜RD_q may be a mobile device, a personal computer or an idle base station. The idle base station refers to a base station, which does not provide service currently or with light load, determined by the coordination server CS. By employing an idle base station as the reference device, the available resources can be fully utilized for channel calibration. If there are multiple idle base stations, the coordination server CS may schedule to decide which idle base station(s) is/are to be used as reference device(s).

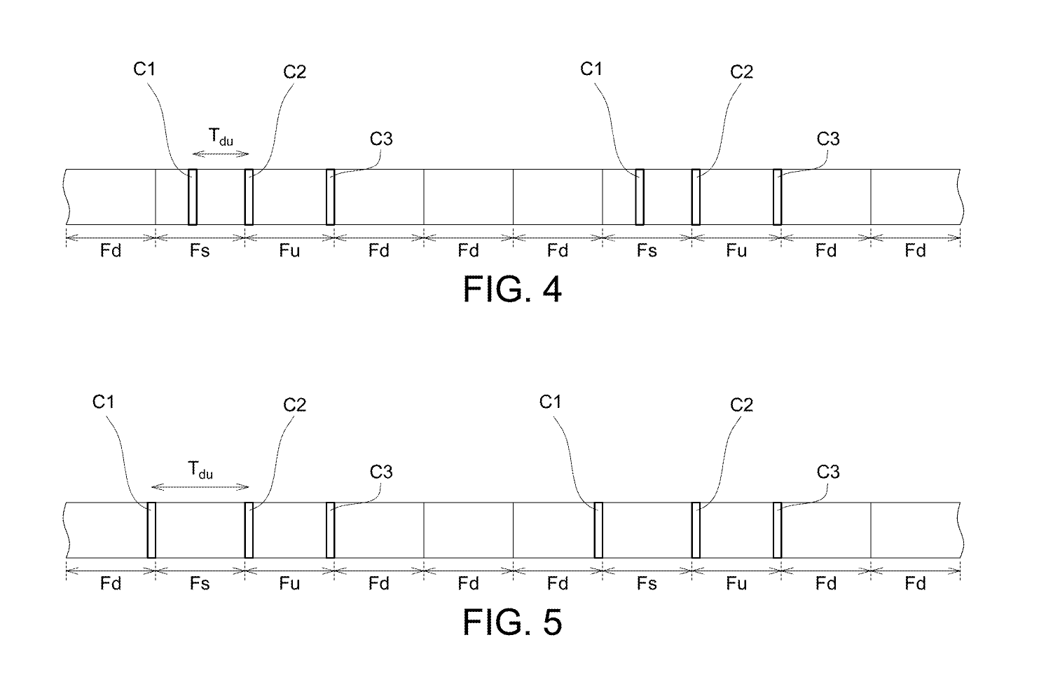

Referring to FIG. 4, FIG. 4 shows a timing diagram of an example of a multi-cell system according to an embodiment of the disclosure. In this embodiment,the downlink reference signal is scheduled in a special sub-frame Fs between a period uplink sub-frame Fu and a downlink period sub-frame Fd for transmission. Further, downlink reference signal is scheduled in a guard period of the special sub-frame for transmission, and then the downlink channel information is derived by the reference devices RD_1˜RD_q (C1) and transmitted to the coordination server CS. The uplink reference signal is scheduled in the uplink period sub-frame Fu for transmission, and then the uplink channel information is derived by the base stations eNB_1˜eNB_p (C2) and transmitted to the coordination server CS. After the base stations eNB_1˜eNB_p deriving the uplink channel information of the user devices UE_1˜UE_s (C3) and transmitting the uplink channel information of the user devices UE_1˜UE_s to the coordination server CS, the base stations eNB_1˜eNB_p may obtain the precoding matrix from the coordination server CS, and the precoding matrix may be used to serve the user devices UE_1˜UE_p in next a number of downlink period sub-frame Fd.

Referring to FIG. 5, FIG. 5 shows a timing diagram of another example of a multi-cell system according to an embodiment of the disclosure. In this embodiment,the downlink reference signal is scheduled in the downlink period sub-frame Fd for transmission, and then the downlink channel information is derived by the reference devices RD_1˜RD_q (C1) and transmitted to the coordination server CS. The uplink reference signal is scheduled in the uplink period sub-frame Fu for transmission, and then the uplink channel information is derived by the base stations eNB_1˜eNB_p (C2) and transmitted to the coordination server CS. After the base stations eNB_1˜eNB_p deriving the uplink channel information of the user devices UE_1˜UE_s (C3) and transmitting the uplink channel information of the user devices UE_1˜UE_s to the coordination server CS, the base stations eNB_1˜eNB_p may obtain the precoding matrix from the coordination server CS, and the precoding matrix may be used to serve the user devices UE_1˜UE_p in next a number of downlink period sub-frame Fd.

In addition, the uplink reference signal and the downlink reference signal may be designed based on the needs to enable the base stations eNB_1˜eNB_p to identify the transmission source of the uplink reference signal (from which reference device/reference device antenna), and also to enable the reference devices RD_1˜RD_q to identify the transmission source of the downlink reference signal (from which base station/base station antenna). In an embodiment,the reference device antennas of the reference devices RD_1˜RD_q may transmit the uplink reference signals by using sub-carriers with different frequencies. For example, the first reference device antenna of the reference device RD_1 transmits the uplink reference signal by using a sub-carrier with a first frequency, the second reference device antenna of the reference device RD_1 transmits the uplink reference signal by using a sub-carrier with a second frequency, and so forth. Or, the reference device antenna of the different reference devices may transmit the uplink reference signals by using sub-carriers with different frequencies. In another embodiment,the reference device antennas of the reference devices RD_1˜RD_q may transmit the uplink reference signals by using different orthogonal coding. For example, the first reference device antenna of the reference device RD_1 transmits the uplink reference signal by using a first orthogonal coding, the second reference device antenna of the reference device RD_1 transmits the uplink reference signal by using a second orthogonal coding, and so forth. Or, the reference device antenna of the different reference devices may transmit the uplink reference signals by using different orthogonal coding.

Similarly, the base station antennas of the base stations eNB_1˜eNB_p may transmit the downlink reference signals by using sub-carriers with different frequencies. Or, the base station antenna of the different base stations may transmit the downlink reference signals by using sub-carriers with different frequencies. In another embodiment,the base station antennas of the base stations eNB_1˜eNB_p may transmit the downlink reference signals by using different orthogonal coding. Or, the base station antenna of the different base stations may transmit the downlink reference signals by using different orthogonal coding.

In addition, in other embodiment,the uplink reference signal and/or the downlink reference signal may be scheduled in a sub-carrier of a guard band for transmission.

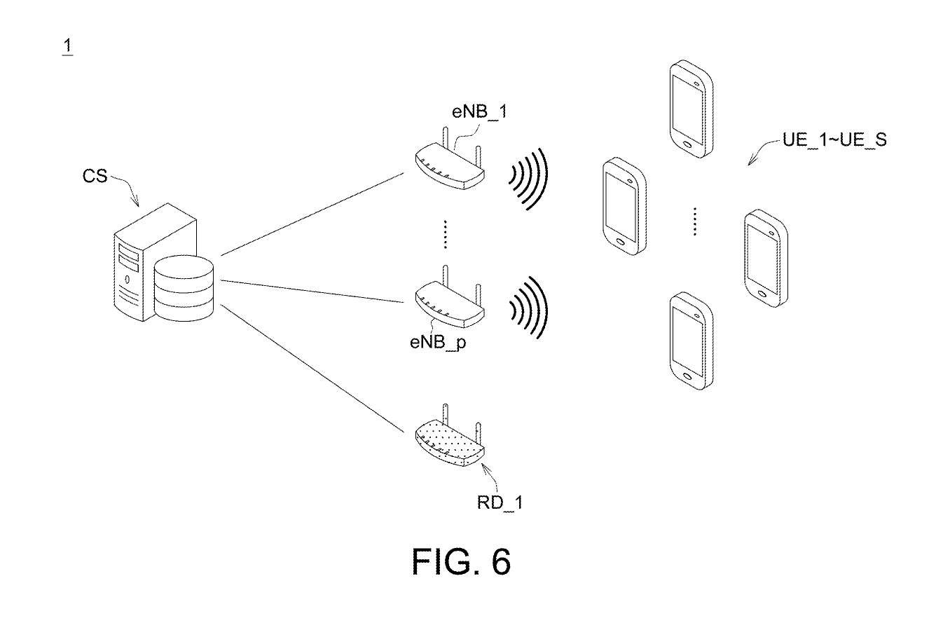

Referring to FIG. 6, FIG. 6 shows a system block diagram of multi-cell system according to another embodiment of the present disclosure. This embodiment is a special case of the embodiment illustrated above, that is, the case that the quantity of the base stations is plural, the quantity of the reference device is one, and the quantity of the reference device antenna is one. In this embodiment,the base stations eNB_1˜eNB_p and the reference device RD_1 employ Global Positioning System (GPS) signals for time synchronization. Each of the base stations eNB_1˜eNB_p, the reference device RD_1 and the user devices UE_1˜UE_s has its own independent clock source. In addition, the standard of Long Term Evolution (LTE) is employed in this embodiment.

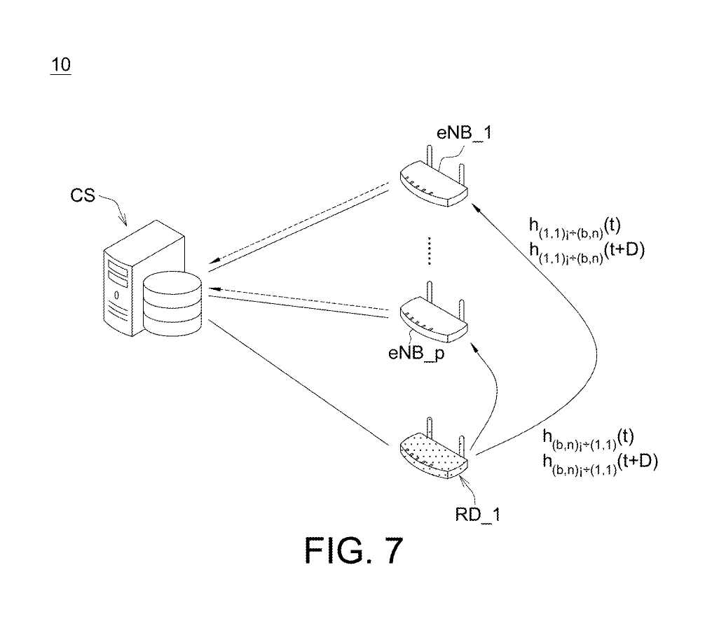

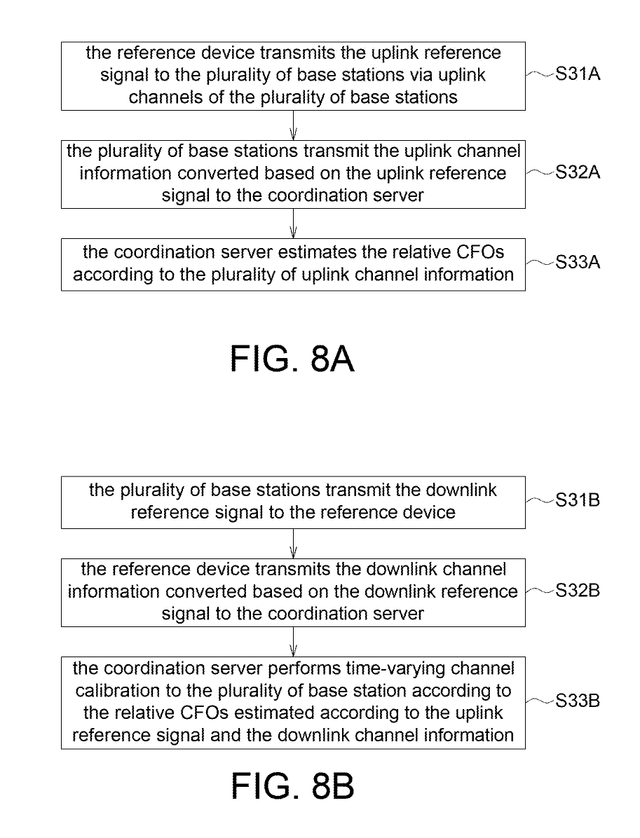

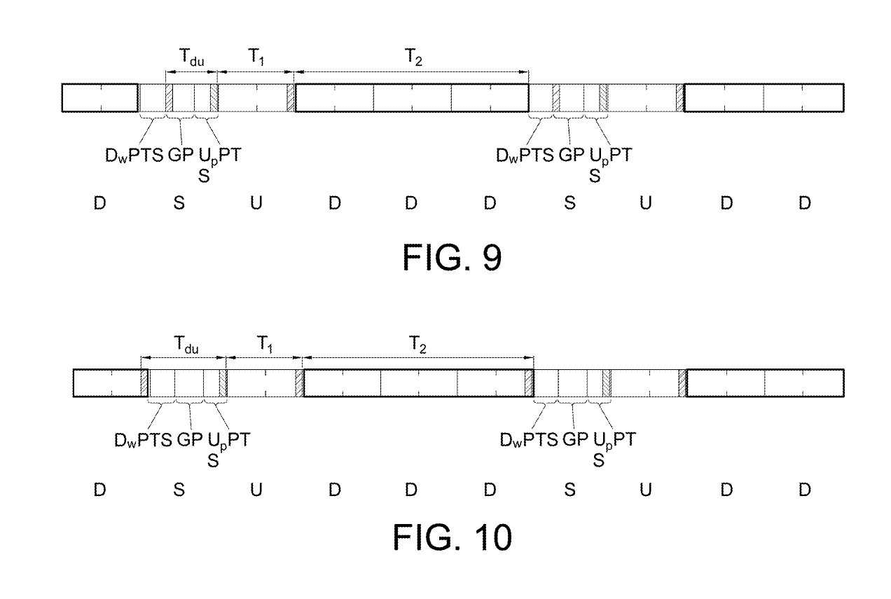

FIG. 8A is a flow chart of the method according to the disclosure. Please also refer to FIG. 7, which is a schematic diagram of inter-eNB CFO estimation. In step S81A, the reference device RD_1 of the MCC system transmits the uplink reference signal to the plurality of base stations eNB_1˜eNB_p via uplink channels of the plurality of base stations eNB_1˜eNB_p. In step S82A, the plurality of base stations eNB_1˜eNB_p transmit the uplink reference signal or the uplink channel information converted based on the uplink reference signal to the coordination server CS. In step S83A, the coordination server CS estimates the relative CFOs according to the uplink reference signal or the plurality of uplink channel information. In an embodiment,the uplink reference signal can be transmitted in an uplink pilot time slot (UpPTS) of an uplink channel, or in an uplink period subframe in an uplink channel, which is adjacent to a next downlink channel, as shown in FIG. 9.

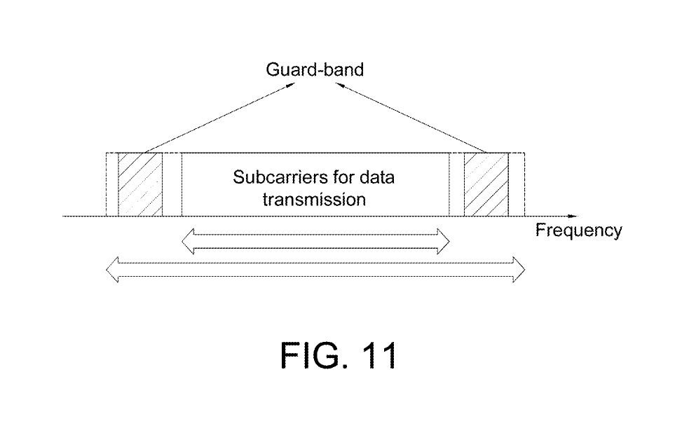

As shown in FIG. 8B, after the coordination server CS estimates and obtains the relative CFOs, in step S81B, the plurality of base stations eNB_1˜eNB_p transmit the downlink reference signal to the reference device RD_1. In step S82B, the reference device RD_1 transmits the downlink reference signal or the downlink channel information converted based on the downlink reference signal to the coordination server CS. In step S83B, the coordination server CS performs time-varying channel calibration to the plurality of base station eNB_1˜eNB_p according to the relative CFOs estimated according to the uplink reference signal and the downlink reference signal or the downlink channel information. In an embodiment,the downlink reference signal can be transmitted in a guard period (GP) of a special subframe between an uplink subframe (uplink period subframe) and a downlink subframe (downlink period subframe), as shown in FIG. 9. In another embodiment, as shown in FIG. 10, the downlink reference signal can be transmitted in a downlink period subframe of a downlink channel near a special subframe. In still another embodiment, as shown in FIG. 11, the downlink reference signal can be transmitted in guard-band sub-carriers.

After obtaining data of the time varying channel calibration, the coordination server CS calculates and transmits the precoders to the plurality of base stations eNB_1˜eNB_p for precoding.

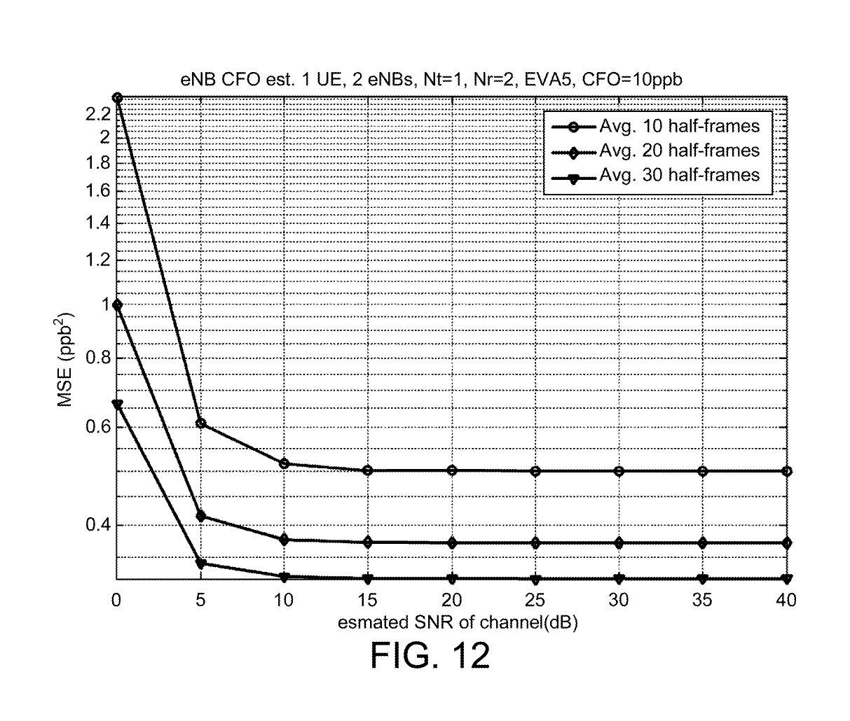

As shown in FIG. 12, which is a graph showing simulation of estimation performance of CFO among eNBs (base stations), it is known from the simulation results of inter-eNB estimation that when the channel estimation Signal-to-Noise (SNR) is high enough (SNR>15 dB), only 10 CFO estimations are required to estimate a Mean Squared Error (MSE) that reaches about 0.7 ppb regardless of whether it is utilized in the channel of 10 half-frame, 20 half-frame, or 30 half-frame. Such efficacies indicate the estimation accuracy of the present disclosure. Moreover, it is not restricted that the CFO estimation of the present disclosure is operated under any specific time, the CFO estimation can be estimated in a periodic or aperiodic time, and then those CFO estimations in different time can be recorded and their average can be calculated.

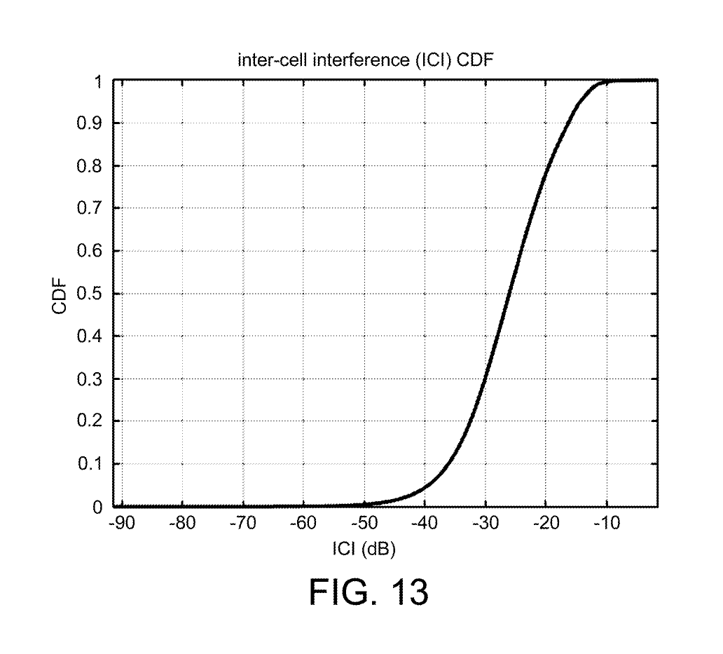

After the aforesaid calibration, as shown in FIG. 13, it can be clearly realized that the inter cell interference (ICI) among eNBs (base stations) is suppressed. The average ICI is suppressed lower than −25 dB, which meets the SNR requirement of 16 QAM transmission.

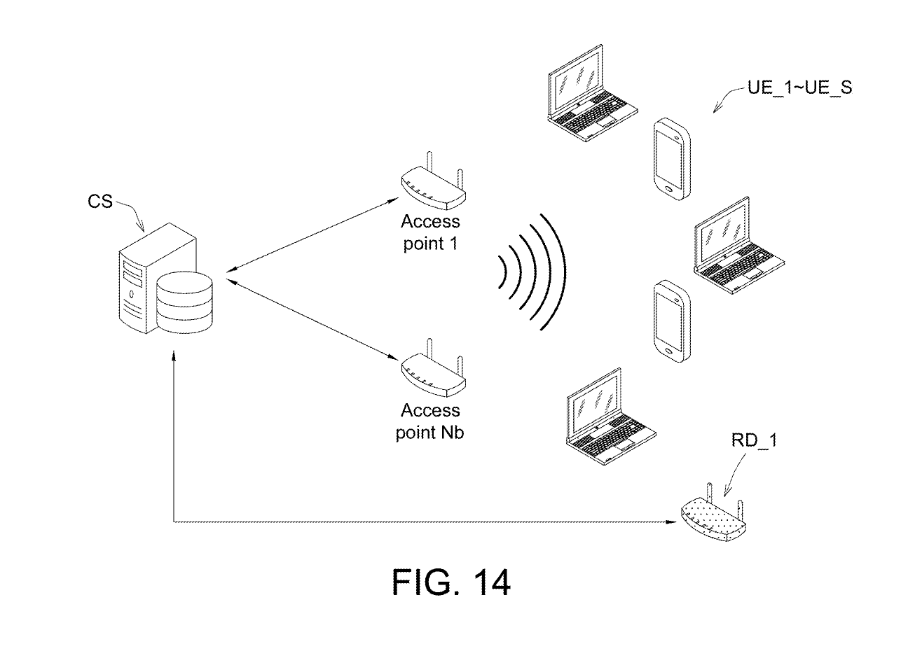

The concepts described above can be applied to systems using LTE protocol, systems using Wi-Fi protocol (e.g., where access points are used as base stations as shown in FIG. 14 (Access Point 1 to Access Point Nb)), or other systems using time-division multiplexing (TDD).With the method or system of the present disclosure, synchronization among base stations, time-varying effect of RF response, and the acquiring of downlink channel state information in the system for coordinating multi-cells can be resolved. The present disclosure provides the addition of at least one reference device in the system for coordinating multi-cells, so that a carrier frequency offset among base stations can be estimated and compensated based on the uplink signals, thus addressing the issue of synchronization between base stations. The reference device(s) also tracks the time-varying effect of RF response in real time based on the received downlink signals and performs channel calibration to obtain downlink channel state information, such that the multi-cell system is able to perform precoding normally and achieve performance that is almost as good as that is achieved by a massive-antenna system. Moreover, as the quantity of the reference device antennas increases, the effect of frequency-selective fading can be more effectively reduced.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-cell system, comprising:
a coordination server, communicated with a plurality of base stations including a plurality of base station antennas, and at least one reference device, the at least one reference device communicated wirelessly with the base stations, and a plurality of reference device antennas disposed on the at least one reference device;
wherein the coordination server derives a plurality of relative carrier frequency offsets (CFO) according to a plurality of uplink channel information received from the base stations, wherein the uplink channel information are derived, by the base stations, according to a plurality of uplink reference signals transmitted from the reference device antennas of the at least one reference device, and
the coordination server derives a plurality of channel calibration coefficients according to the uplink channel information, the relative CFOs and a plurality of downlink channel information received from the at least one reference device, wherein downlink channel information are derived, by the at least one reference device, according to a plurality of downlink reference signals transmitted from at least one of the base station antennas among the base station antennas of each of the base stations.

2. The multi-cell system according to claim 1, wherein the quantity of the at least one reference device is plural, and the quantity of the reference device antenna of each of the reference devices is one, or the quantity of the at least one reference device is one, and the quantity of the reference device antennas of each of the reference device is plural.

3. The multi-cell system according to claim 1, wherein the coordination server derives a precoding matrix according to the relative CFOs and the channel coefficients, and transmits the precoding matrix to the base stations.

4. The multi-cell system according to claim 1, wherein each of the uplink reference signals is scheduled in an uplink period sub-frame.

5. The multi-cell system according to claim 1, wherein the reference device antennas of the at least one of the reference device transmit the uplink reference signals by using sub-carriers with different frequencies, and the base station antennas of the base stations transmit the downlink reference signals by using sub-carriers with different frequencies.

6. The multi-cell system according to claim 1, wherein the reference device antennas of the at least one of the reference device transmit the uplink reference signals by using different orthogonal coding, and the base station antennas of the base stations transmit the downlink reference signals by using different orthogonal coding.

7. The multi-cell system according to claim 1, wherein each of the downlink reference signals is scheduled in a downlink period sub-frame, or a guard period between an uplink period sub-frame and the downlink period sub-frame.

8. The multi-cell system according to claim 1, wherein each of the downlink reference signals is scheduled in a sub-carrier of a guard band.

9. The multi-cell system according to claim 1, wherein the coordination server derives the relative CFOs and the channel calibration coefficients by using weight combining, the relative CFOs have a first gain, and the channel calibration coefficients have a second gain.

10. The multi-cell system according to claim 1, wherein one of the at least one reference device is a mobile device, a personal computer or an idle base station.

11. A channel calibration method of a multi-cell system, comprising:
deriving, by a coordination server, a plurality of relative carrier frequency offsets (CFO) according to a plurality of uplink channel information received from a plurality of base stations, wherein the uplink channel information are derived, by the base stations, according to a plurality of uplink reference signals transmitted from a plurality of reference device antennas disposed on at least one reference device; and
deriving, by the coordination server, a plurality of channel calibration coefficients according to the uplink channel information, the relative CFOs and a plurality of downlink channel information received from the at least one reference device, wherein the downlink channel information are derived, by the at least one reference device, according to a plurality of downlink reference signals transmitted from at least one base station antenna among a plurality of base station antennas of each of the base stations.

12. The channel calibration method according to claim 11, wherein the quantity of the at least one reference device is plural, and the quantity of the reference device antenna of each of the reference devices is one, or the quantity of the at least one reference device is one, and the quantity of the reference device antennas of each of the reference device is plural.

13. The channel calibration method according to claim 11, further comprising:
deriving, by the coordination server, a precoding matrix according to the relative CFOs and the channel coefficients; and
transmitting, by the coordination server, the precoding matrix to the base stations.

14. The channel calibration method according to claim 11, wherein each of the uplink reference signals is scheduled in an uplink period sub-frame.

15. The channel calibration method according to claim 11, wherein the reference device antennas of the at least one of the reference device transmit the uplink reference signals by using sub-carriers with different frequencies, and the base station antennas of the base stations transmit the downlink reference signals by using sub-carriers with different frequencies.

16. The channel calibration method according to claim 11, wherein the reference device antennas of the at least one of the reference device transmit the uplink reference signals by using different orthogonal coding, and the base station antennas of the base stations transmit the downlink reference signals by using different orthogonal coding.

17. The channel calibration method according to claim 11, wherein each of the downlink reference signals is scheduled in a downlink period sub-frame, or a guard period between an uplink period sub-frame and the downlink period sub-frame.

18. The channel calibration method according to claim 11, wherein each of the downlink reference signals is scheduled in a sub-carrier of a guard band.

19. The channel calibration method according to claim 11, wherein the coordination server derives the relative CFOs and the channel calibration coefficients by using weight combining, the relative CFOs have a first gain, and the channel calibration coefficients have a second gain.

20. The channel calibration method according to claim 11, wherein one of the at least one reference device is a mobile device, a personal computer or an idle base station.

21. A channel calibration method of a multi-cell system, comprising:
transmitting, by a reference device, the uplink reference signal to a plurality of base stations via uplink channels of the plurality of base stations so as to transmit a plurality of uplink channel information based on the uplink reference signal from the plurality of base stations to a coordination server;
estimating relative carrier frequency offsets (CFOs) among the plurality of base stations by the plurality of uplink channel information;
transmitting, by the plurality of base stations, the downlink reference signal to the reference device so as to transmit a plurality of downlink channel information based on the downlink reference signal from the reference device to the coordination server; and
performing, by the coordination server, a time-varying channel calibration for the plurality of base stations according to the relative CFOs and the plurality of downlink channel information.

22. The channel calibration method of claim 21, wherein the downlink reference signal is arranged to be transmitted in a special subframe between an uplink period subframe and a downlink period subframe.

23. The channel calibration method of claim 22, wherein the downlink reference signal is arranged to be transmitted in a guard period in the special subframe.

24. The channel calibration method of claim 21, wherein the downlink reference signal is arranged to be transmitted in a downlink period subframe.

25. The channel calibration method of claim 21, wherein the downlink reference signal is arranged to be transmitted in guard-band sub-carriers.

26. The method of claim 21, wherein the uplink reference signal is arranged to be transmitted in an uplink pilot time slot or a uplink priod subframe.

27. The channel calibration method of claim 21, wherein the channel calibration method is applicable to LTE protocol or Wi-Fi protocol.

28. A multi-cell system, comprising:
a coordination server;
a plurality of base stations configured for exchanging data with the coordination server; and
a reference device configured for exchanging data with the coordination server and connected with the plurality of base stations through wireless transmission,
wherein the reference device transmits the uplink reference signal to the plurality of base stations via uplink channels of the plurality of base stations so as to transmit a plurality of uplink channel information based on the uplink reference signal from the plurality of base stations to the coordination server, the plurality of base stations transmit the downlink reference signal to the reference device so as to transmit a plurality of downlink channel information based on the downlink reference signal from the reference device to the coordination server, relative carrier frequency offsets (CFOs) among the plurality of base stations are estimated according to the plurality of uplink channel information, and the coordination server performs a time-varying channel calibration for the plurality of base stations according to the relative CFOs and the plurality of downlink channel information.

29. The multi-cell system of claim 28, wherein the plurality of base stations are arranged to transmit the downlink reference signal in a special subframe between an uplink period subframe and a downlink period subframe for transmission.

30. The multi-cell system of claim 29, wherein the plurality of base stations are arranged to transmit the downlink reference signal in a guard period in the special subframe.

31. The multi-cell system of claim 28, wherein the downlink reference signal are arranged to be transmitted in a downlink period subframe.

32. The multi-cell system of claim 28, wherein the plurality of base stations are arranged to transmit the downlink reference signal in guard-band sub-carriers.

33. The multi-cell system of claim 28, wherein the reference device is arranged to transmit the uplink reference signal in an uplink pilot time slot or a uplink period subframe.

34. The system of claim 28, wherein the multi-cell system is applicable to an LTE protocol environment or a Wi-Fi protocol.
